(19) United States
(12) Patent Application Publication
(10) Pub. No.: US 2007/0192126 A1
(43) Pub. Date: Aug. 16, 2007

(54) System and method for partner inclusion into an enterprise network

(75) Inventor: Jai Ganesh, (US)

Correspondence Address: NIXON PEABODY, LLP, 401 9TH STREET, NW, SUITE 900, WASHINGTON, DC, 20004-2128, US

(73) Assignee: INFOSYS TECHNOLOGIES, LTD.

(21) Appl. No.: 11/655,872

(22) Filed: Jan. 22, 2007

(30) Foreign Application Priority Data
Jan. 25, 2006 (IN) 114/CHE/2006

(51) Int. Cl. G06Q 10/00; G06Q 30/00

(52) U.S. Cl. 705/1

(57) ABSTRACT

An automated system, method, and computer program product for enabling a real time transaction through a web service enabled supplier service network involving at least one supplier and at least one buyer, including providing a forward auction service to the at least one seller for selling at least one item and providing a reverse auction service to the at least one buyer for buying the item proposed by the at least one seller. The invention also includes providing a catalog based procurement service to the at least one seller and the at least one buyer and providing a payment service for providing credits and/or debits information to the at least one buyer and/or seller using a third party payment service. The invention may also include providing a logistics service to the at least one buyer for purchased items using a third party distribution service.

### CROSS REFERENCE TO RELATED DOCUMENTS

This application claims priority under 35 U.S.C. §119 to Indian Patent Application Serial No. 114/CHE/2006 of GANESH, entitled “SYSTEM AND METHOD FOR PARTNER INCLUSION INTO AN ENTERPRISE NETWORK,” filed Jan. 25, 2006, the entire disclosure of which is hereby incorporated by reference herein.

### BACKGROUND OF THE INVENTION

1. Field of the Invention

The present invention relates generally to an enterprise network and more particularly, to a system and method for including at least one partner into the enterprise network using a web services enabled supplier service network.

2. Discussion of the Background

A network is a series of nodes, e.g., devices interconnected by communication paths. Networks may interconnect with other networks and include sub networks. Also, networks may be characterized in terms of spatial distance, e.g., local area networks (LAN) or wide area networks (WAN). Networks include network devices such as routers, switches, and so forth. A partner may be defined as vendors or suppliers capable of offering a set of services to the enterprise network. The term web services has come to denote open standards based information exchange between applications using eXtensible markup language (XML) messages following a service oriented architecture (SOA). XML is used for describing structured data having self descriptive capabilities through the use of extensible, customizable tags. Likewise, in SOA, the software functionality is encapsulated as a service and is made accessible over the network. The uniqueness of this service lies in the fact that these services could be exposed to the external world, searched by the service customers or partners and assessed through the use of machine readable descriptions and interfaces.

Typically, network devices or services come from different vendors that may have different sets of management data. Even network devices or services from the same vendor may have different sets of data. The network operator must also be familiar with how to map the differences between vendors and different management technologies (protocols) to one another in order to configure a network to behave in a correct fashion. The network management software maps high-level business service requirements and agreements into policies that include low-level commands and management objects that configure these services.

There are challenges for integration of supplier and buyer systems with the private marketplaces of enterprises due to the large number of point-to-point connections required. This results in lower transaction efficiency and lead times for interorganisational commerce and collaboration.

The existing solutions depend on time-consuming and complex point-to-point connections between the enterprise marketplaces with its partners. The existing solutions connect partner systems with enterprise systems through proprietary interfaces. Also, in some cases, there may be integration solutions from EAI vendors involve large initial investments. Further, it is not easy to work around with EAI systems while integrating with IT systems of different partners with heterogeneous systems.

The existing systems and methods available are time-consuming and complicated to implement as they involve building point-to-point connections between the enterprise marketplaces with its partners. Given the heterogeneity of partner systems interacting with the enterprise, the existing solutions turns out to be expensive as they use proprietary interfaces.

Accordingly, there is a need for a technique that increases the transaction efficiency and reduces the lead times for interorganizational commerce and collaboration using open standards for integration and collaboration.

### SUMMARY OF THE INVENTION

In one embodiment of the present technique, an automated method of enabling a real time transaction through a web service enabled supplier service network involving at least one supplier and at least one buyer is disclosed. The method includes providing a forward auction service to the at least one seller for selling at least one item and providing a reverse auction service to the at least one buyer for buying the item proposed by the at least one seller. The method further includes providing a catalog based procurement service to the at least one seller and the at least one buyer and providing a payment service for providing credits and/or debits information to the at least one buyer and/or seller using a third party payment service. Furthermore, the method involves providing a logistics service to the at least one buyer for purchased items using a third party distribution service and wherein, the payment service and logistics service are provided using a web service interface.

In another embodiment of the present technique, a system of enabling a real time transaction through a web service enabled supplier service network involving at least one supplier and at least one buyer is disclosed. The system includes a process engine operable to execute a plurality of services to perform the real time transaction based on a workflow and a database operable to store a plurality of data relating to the real time transaction. The system further includes a display module configured to display information on the real time transaction and a payment module adapted for providing a third party payment service for determining and processing payment terms of the at least one buyer. In addition to this, the system also includes a logistics module adapted for providing a third party logistics service to the at least one buyer for purchased items using a third party distribution service and wherein, the payment service and logistics service are provided using a web service interface.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a schematic of a system illustrating a web service enabled supplier service network, in accordance with an aspect of the present technique;

FIG. 2 is a flowchart illustrating a method for registration of a buyer or a seller in the web service enabled supplier service network, in accordance with an aspect of the present technique;

FIG. 3 is a flowchart illustrating a method for searching prospective buyers by the seller, in accordance with an aspect of the present technique;

FIG. 4 is a flowchart illustrating a method for creating reverse auction by the buyer, in accordance with an aspect of the present technique;

FIG. 5 is a flowchart illustrating a method for creating forward auction by the seller, in accordance with an aspect of the present technique;

FIG. 6 is a flowchart illustrating a method for selling items by the seller through forward auction, in accordance with an aspect of the present technique;

FIG. 7 is a flowchart illustrating a method for searching items by the buyer, in accordance with an aspect of the present technique;

FIG. 8 is a flowchart illustrating a method for listing items by the seller for sale in catalog based procurement service, in accordance with an aspect of the present technique; and

FIG. 9 is a flowchart illustrating a method for buying items through reverse auction, in accordance with an aspect of the present technique.

### DETAILED DESCRIPTION OF THE PREFERRED EMBODIMENTS

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

The present invention relates to techniques for including and managing marketplace (suppliers and buyers) in an enterprise network. As will be appreciated by people skilled in the art, to best understand the present invention it is important to be familiar with the environment and the basic terminologies.

Marketplaces are places where buyers and suppliers (also referred as partners) meet to exchange information about prices and products and service offerings, and to negotiate and carry out transactions. They are at the centre of the current growth to business to business (B2B) and business to consumer (B2C) markets. Transaction generally refers to either selling or buying of items by the seller or the buyer respectively. Transaction may also include payment transaction or logistics transaction or any other activities related to the buying or selling of any item in the marketplace.

The term web services has come to denote open standards based information exchange between applications using XML messages following a service oriented architecture (SOA). The messages being in plain text XML, the connection end points sending and receiving the messages can be of diverse platform and technologies. In the service oriented architecture, the software functionality is encapsulated as a service and is made accessible over the network. The uniqueness of this service concept lies in the fact that these services could be exposed to the external world, searched by the service consumers and accessed through the use of machine readable descriptions and interfaces.

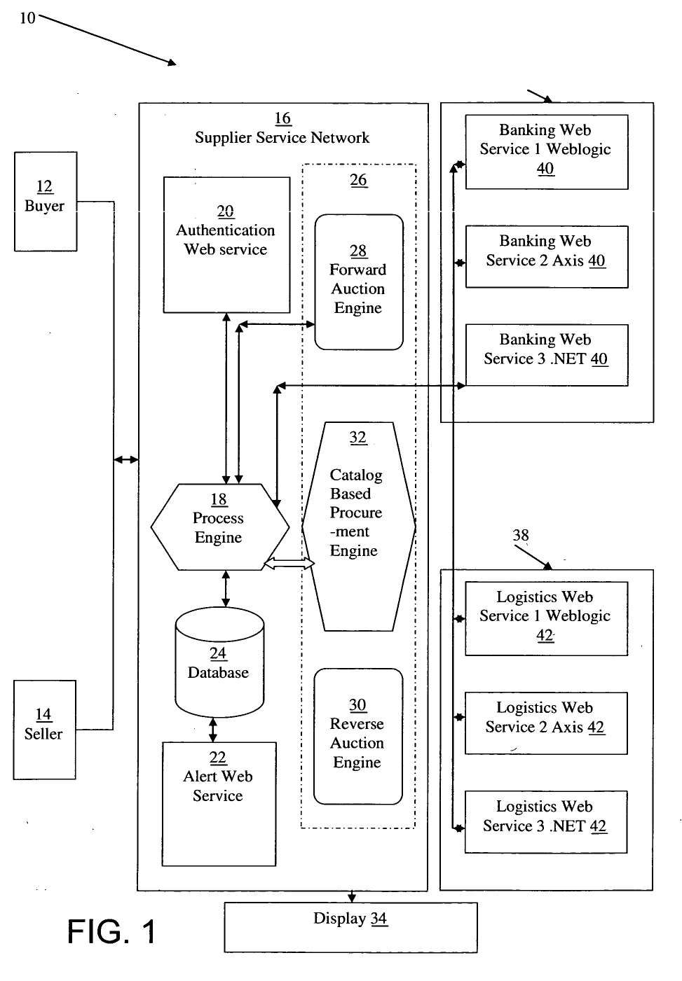

Referring now to figures, FIG. 1 depicts a schematic of a system 10 illustrating a web service enabled supplier service network, in accordance with an aspect of the present technique. As illustrated, the system 10 includes at least one buyer 12 and at least one seller 14. Typically, the buyer 12 would like to buy items from any seller 14 and likewise, the seller 14 would like to sell his items to a prospective buyer 12.

In one embodiment of the present technique, the present system 10 comprises an option of including new suppliers to the web services enables supplier service network. Likewise, the system may also allow new buyers to include in the supplier service network.

The system 10 further includes a supplier service network 16 comprising of a process engine 18, an authentication web service module 20, an alert web service module 22, a database 24 and a service module 26. The service module 26 includes multiple service engines, which will be explained in detail in the subsequent sections to follow. As indicated, the supplier service network 16 includes the process engine 18, wherein the process engine 18 may be operable to execute multiple services to perform a real time transaction based on a workflow.

In the present context, real time transaction may be defined as a set of transaction, which occurs in real time and may include at least one of selling or buying or paying or receiving payments or distribution or delivery deadlines or combinations thereof.

Likewise, the workflow may be defined as a description of a process in terms of the steps or tasks or jobs that comprise the process. Like a flow diagram, a workflow describes the steps in a process and the dependency among steps. Each step is a task to be performed in the process. A workflow definition may include a description of the desired behavior that occurs when a step is executed and a description of step dependencies in terms of steps and data. A step dependency may include a dependency on the state of one or more steps and/or the state or value of one or more data variables.

In addition, the workflow definition describes dependencies among the steps in the process. These dependencies may include dependencies among steps based on the state of another step such as whether another step has been performed successfully or is currently being performed. The dependency may also be based on the state of data, such as whether data is ready to be used as input to a step, or whether the value of a specified data variable calculated during a step has a pre-defined value.

As illustrated in FIG. 1, the supplier service network 16 further includes the authentication web service 20, which verifies and authorizes the user authentication. Authentication Service is being used to authenticate the user. The Authentication services can be deployed in any platform as long as they conform to the WS-Security standards. The Authentication web service takes the user's username and password and validates it against the database and creates a username token if the credentials are valid and sends the SOAP response back. The Authentication service then checks the SOAP header for tokens. If token is present then the user is validated and logged in else he is asked to authenticate again.

The alert web service module 22 may be adapted in case when an event such as a user getting outbid or a winning a bid happens an alert is sent to the user to the mail id that was provided during registration. When the web service is called it in turn puts the alert request in a queue. When the agent at the server is running it takes the data from the queue and dispatches it to the users. Alerts are send whenever a bidder x loses a bid to another bidder y or the bidder x wins a bid. An email is sent to the bidder x's email ID. This is the same id that the bidder x had provided during the time of registration in the marketplace. Alert is sent to a bidder x when bidder y outbids bidder x in a forward or a reverse auction. Alert is also sent to a bidder x when the auction item for which x was winning the bid is closed.

As illustrated, the multiple services of the service module 26 includes at least one of providing a forward auction service (forward auction engine 28) to the at least one seller for selling at least one item or providing a reverse auction service (reverse auction engine 30) to the at least one buyer for buying the item proposed by the at least one seller or providing a catalog based procurement service (catalog based procurement engine 32) to the at least one seller 14 and the at least one buyer 12 or combinations thereof.

In the forward auction engine 28, the seller 14 indicates to the system 10 that he wishes to create a forward auction to sell an item. Forward auction refers to the auction where the buyers come and bid for an item. The buyer who places the highest bid wins the auction and gets the item. The popular forward auction format is the English auction. English auction allows all participants to know the highest current bid and decide whether or not to bid in excess of that amount. Online English auctions allow the participation of a larger number of sellers and the responses can be received within hours or days rather than seconds. The English auction format is suitable for sales by companies holding excess inventory, companies that buy out-of-date inventory, or companies simply trying to reach a larger marketplace. The system 10 requests the seller 14 to enter the forward auction information. The seller enters the forward auction information (time out, reserve price etc.) and the system shows the auction information to the seller 14 and requests that the seller 14 to confirm. The seller 14 confirms/modifies the auction information and the system then creates a forward auction. The forward auction process is now initiated. The system 10 sets a trigger to be sent to the seller 14 when the auction time out happens.

In the reverse auction engine 30, the flow starts when the buyer 12 indicates to the system 10 that he wishes to create a reverse auction to buy an item. Reverse auction refers to the auction format adopted when sellers bid to sell an item. The seller who quotes the least price for the item wins the auction and gets to sell the item to the buyer. A buyer can start a reverse auction by specifying an item he wants to buy and sellers compete amongst themselves to achieve the lowest bid. The buyer starts the bidding at a price deemed to be a fair starting point, which is the equivalent of the reserve price in an English auction. The price is revealed and the bidding begins. The sellers start to bid lower and lower for the contract (the price at which they are willing to sell the items to the buyer) until a low bid is reached and there are no more offers. At this point, the contract for the items is given to the lowest bidder. The system 10 requests the buyer 12 to enter the reverse auction information. The buyer 12 enters the reverse auction information (time out, reserve price etc.) and the system 10 shows the auction information to the buyer 12 and requests that the buyer 12 to confirm. The buyer 12 confirms/modifies the auction information and the system 10 then creates a reverse auction. The system 10 sets a trigger to be sent to the buyer 12 when the auction time out happens.

In the catalog based procurement engine 32, at least four scenarios may occur. In the first case, the seller may lists items for sale in the catalog steps, wherein the seller indicates to the system that he wishes to sell an item. The system requests the seller to enter the item details North American Industry Classification System (NAICS) code, price, quantity, discounts (if any), comments (if any) and the system 10 shows the information to the seller 14 and requests that the seller 14 to confirm. The seller 14 confirms/modifies the item sale information and the system 10 then creates the sale. The sale process may then be initiated. The system 10 displays the message that “sale has been created” in a display module.

In the second case, the buyer 12 searches the catalog based procurement services, wherein the buyer 12 requests the system 10 for specific items, which are for sale (non-auction) and the system 10 allows the buyer 12 to search by a specific category or by using keywords. The system 10 then searches the items and the search results are then displayed to the buyer 12. The system 10 provides item details as per the request. If the requested item details are not available, then the appropriate message is displayed and in this case, the buyer 12 is given the option of refining his search criteria.

In the third case, the seller 14 searches catalog, wherein the seller 14 requests the system 10 for specific items, which are for sale (non-auction). The system 10 allows the seller 14 to search by a specific category or by using keywords and the system 10 then searches the items. The search results are then displayed to the seller 14. The system 10 provides item details as per the request. If the requested item details are not available, then the appropriate message is displayed in the display module 34. In this case, the seller 14 may be given the option of refining his search criteria.

In the fourth case, the buyer buys items from the catalog, wherein the buyer logs in into the system and searches for an item on sale either through a blind search or through specific item search based on the NAICS code. The system presents the buyer with items on sale [including details such as no. of items available, price, delivery time period, discounts (if any)]. The buyer chooses to buy/not buy the item/s and the system confirms the shipping address. The buyer pays for the item through the third party payment service provider application, which is listed as a Web service in the registry. The system links up with the third party logistics service provider application, which is listed as a Web service in the registry. The system informs the seller that the item has been sold.

It should be noted that though reference is made to the above four scenarios, as will be appreciated by those skilled in the art many other similar scenarios may be possible using the above technique.

As illustrated, the supplier service network 16 further includes a database 24 operable to store a plurality of data relating to the real time transaction. The plurality of data may include but not limited to seller data such as transaction ID, transaction date, transaction time, transaction amount, transaction history, transactions won, bank account details, delivery details, address, item name, item details etc., buyer data such as transaction ID, transaction date, transaction time, transaction amount, transaction history, transactions won, bank account details, delivery details, address, item name, item details etc.

Referring back to FIG. 1, the system 10 further includes the display module 34, a payment module 36 and a logistics module 38. The display module 34 may be configured to display information on the real time transaction. By way of an example, the information may include at least one of buyer specific catalog based on pre-set preferences or seller specific catalog based on items for sale or transportation options or combinations thereof.

In certain embodiment of the present technique, the display module 34 may be adapted to display buyer specific catalog based on pre set preferences. Likewise, the display module 34 may be adapted to display seller specific catalog based on items for sale. In another embodiment of the present technique, the display module 34 may be adapted to display transportation options using the logistics module 38. In the present context, the transportation options include at least one of mode of delivery or time of delivery or combinations thereof.

The payment module 36 may be adapted for providing a third party payment service for determining and processing payment terms of the at least one buyer or the seller. It should be noted that the third party payment service comprises a payment gateway. As illustrated in FIG. 1, the payment module 36 may include multiple banking web services 40. In the illustrated FIG. 1, there are three banking web services shown.

Likewise, the system 10 also includes a logistics module 38 adapted for providing a third party logistics service to the at least one buyer 12 or the at least one seller 14 for purchased items using a third party distribution service. It should also be noted that the third party logistics service comprises a logistics gateway. As illustrated, the logistics module 38 may include multiple logistics web services 42. As will be appreciated by a person skilled in the art, the payment service and logistics service are provided using a web service interface.

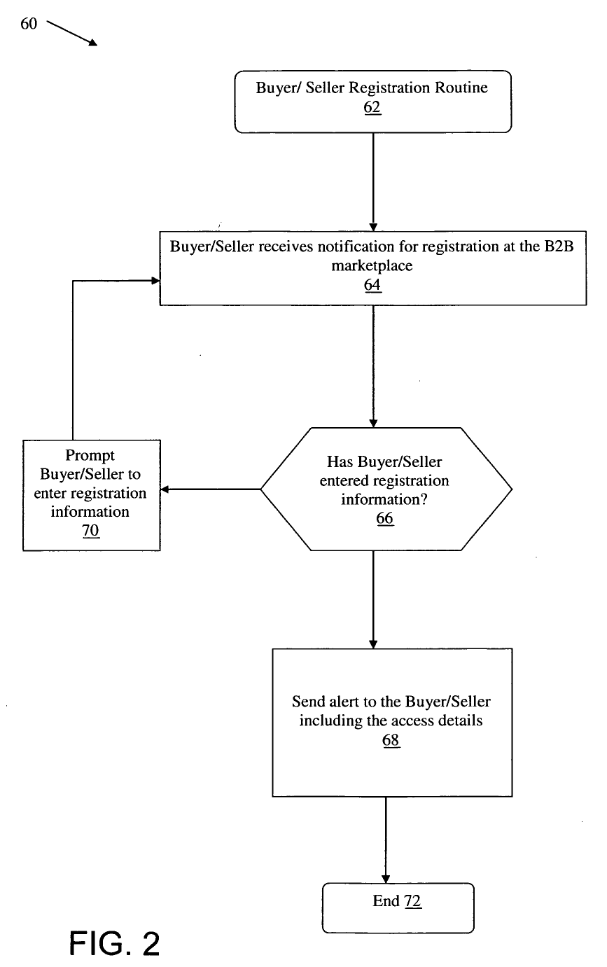

FIG. 2 is a flowchart illustrating a method 60 of registration of a buyer or a seller in the web service enabled supplier service network, in accordance with an aspect of the present technique. As illustrated, the method 60 includes registration routine of the buyer or the seller in step 62. The method continues in step 64, wherein the buyer or the seller or both receives notification for registration at the business to business marketplace. Business to business marketplace may be defined as market makers and intermediaries whose primary roles are to match buyers and sellers, broker deals, and facilitate transactions. Buyers and sellers need intermediaries to find each other and do business, a process that might otherwise require a costly and time consuming search. Business to business marketplaces makes this process very easy and cost effective. At step 66, the decision box determines if the buyer or the seller has entered registration information. If the answer is “yes”, then an alert is sent to the buyer or/and the seller including the details for accessing the network (block 68). If the answer is “no”, then the seller or the buyer needs to enter the registration information again, which proceeds to step 64 again (block 70). The method thus concludes at step 72.

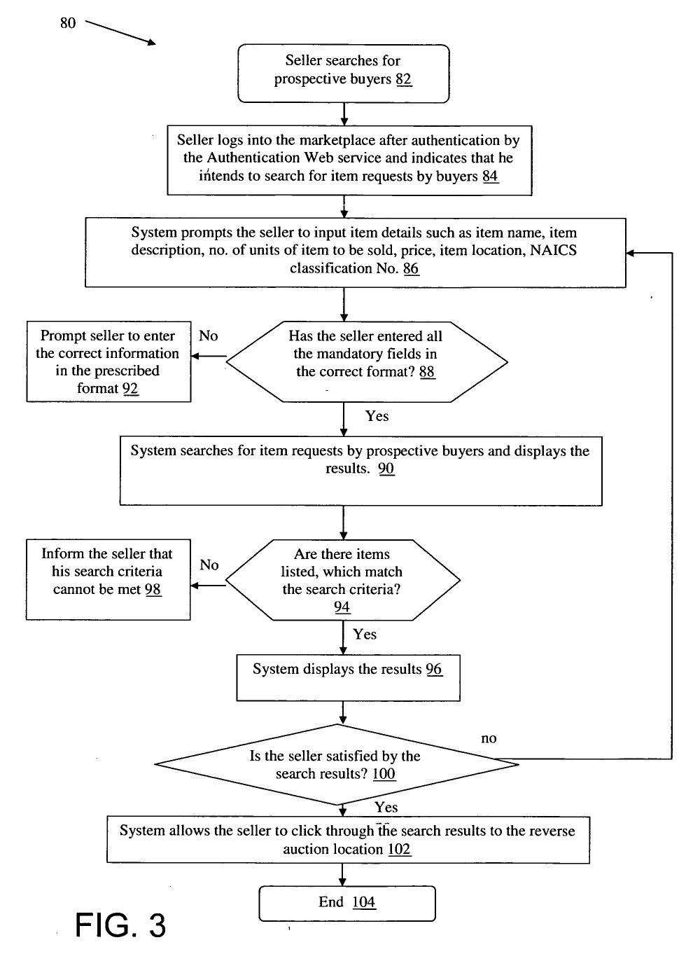

FIG. 3 is a flowchart illustrating a method 80 of searching prospective buyers by the seller, in accordance with an aspect of the present technique. The method 80 starts at step 82, wherein the seller searches for prospective buyers. At step 84, the sellers logs into the marker place after authentication by the authentication web service and indicates that he intends to search fir item requested by the buyer. At step 86, the system prompts the seller to input item details such as item name, item description, number of units to be sold, price, item location, NAICS classification no etc. At step 88, the decision box determines if the seller entered all the mandatory fields in the correct format. If the answer is “yes”, then the system searches for item requested by prospective buyers and display the results in the display module (block 90). If the answer is “no”, then the seller is prompted to enter the correct information in the prescribed format (block 92). The method continues in step 94, where a decision box determines if there are any items, which match the search criteria. If the answer is “yes”, then the system displays the results (block 96). If the answer is “no”, then the seller is informed that his search criteria did not meet (block 98). At step 100, it is determined if the seller is satisfied by the search results. If the answer is “yes”, then the system allows the seller to click through the search results to the reverse auction location (block 102). If the answer is no, then the method 80 goes back to step 86. The method 80 concludes at step 104.

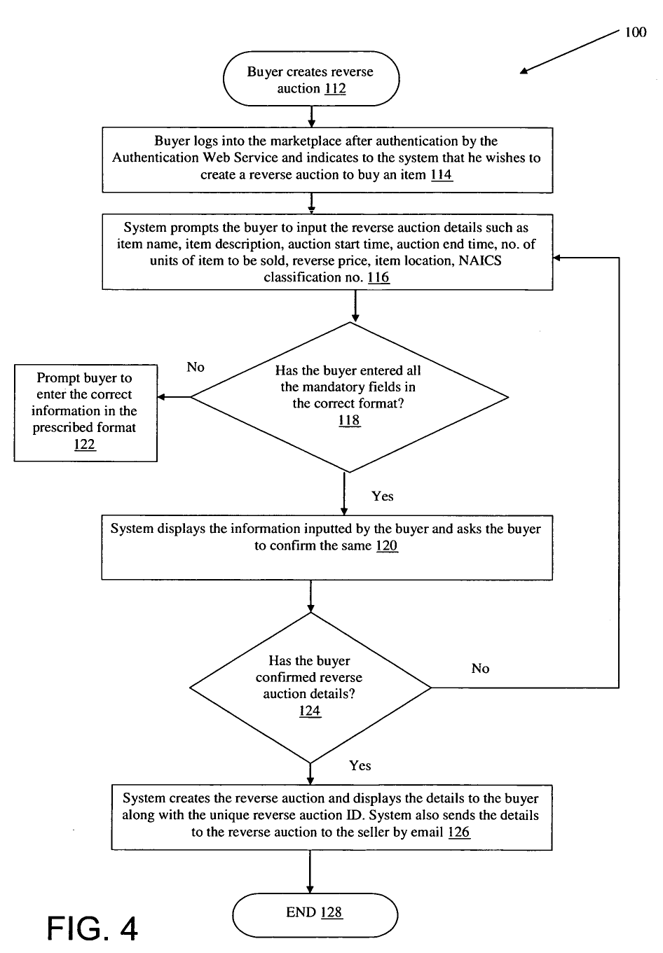

FIG. 4 is a flowchart illustrating a method 110 for creating reverse auction by the buyer, in accordance with an aspect of the present technique. The method 110 starts at step 112, wherein the buyer creates reverse auction. At step 114, the buyer logs into the marketplace after authentication by the authentication web service and indicate to the system that he wishes to create a reverse auction to buy an item. At step 116, the system prompts the buyer to input the reverse auction details such as item name, item description, auction start time, auction end time, number of units of item to be sold, reserve price, item location, NAICS classification number etc. At step 118, the decision box determines if the buyer has entered all the mandatory fields in the correct format. If the answer is “yes”, then at step 120, the system displays the information inputted by the buyer and asks the buyer to confirm the same. If the answer is “no”, then at step 122, the system prompts the buyer to enter the correct information in the prescribed format. The method 110 continues at step 124, wherein a decision is taken whether the buyer confirmed the reverse auction details. If the answer is “no”, then the method 110 moves to step 116. If the answer is “yes”, then at step 126, the system creates the reverse auction and displays the details to the buyer along with the unique reverse auction identification. In one embodiment of the present embodiment, the system also sends the details to the reverse auction to the seller by email. The method concludes at step 128.

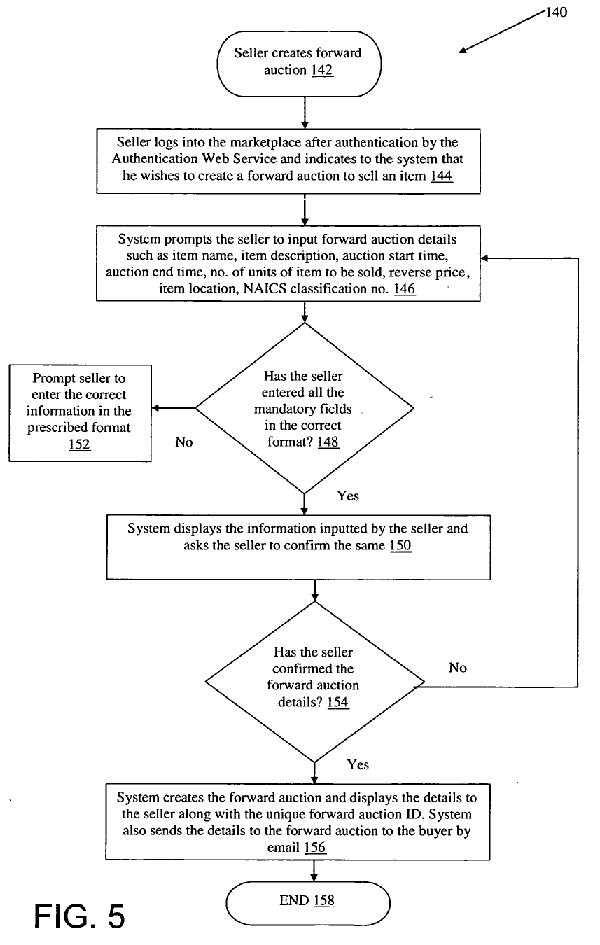

FIG. 5 is a flowchart illustrating a method 140 for creating forward auction by the seller, in accordance with an aspect of the present technique. The method 140 starts at step 142, wherein the seller creates forward auction. At step 144, the seller logs into the marketplace after authentication by the authentication web service and indicate to the system that he wishes to create a forward auction to sell an item. At step 146, the system prompts the seller to provide the forward auction details such as item name, item description, auction start time, auction end time, number of units of item to be sold, reserve price, item location, NAICS classification number etc. At step 148, the decision box determines if the seller has entered all the mandatory fields in the correct format. If the answer is “yes”, then at step 150, the system displays the information inputted by the seller and asks the seller to confirm the same. If the answer is “no”, then at step 152, the system prompts the seller to enter the correct information in the prescribed format. The method 140 continues at step 154, wherein a decision is taken whether the seller confirmed the forward auction details. If the answer is “no”, then the method 140 moves to step 146. If the answer is “yes”, then at step 156, the system creates the forward auction and displays the details to the seller along with the unique forward auction identification. In one embodiment of the present embodiment, the system also sends the details to the forward auction to the buyer by email. The method concludes at step 158.

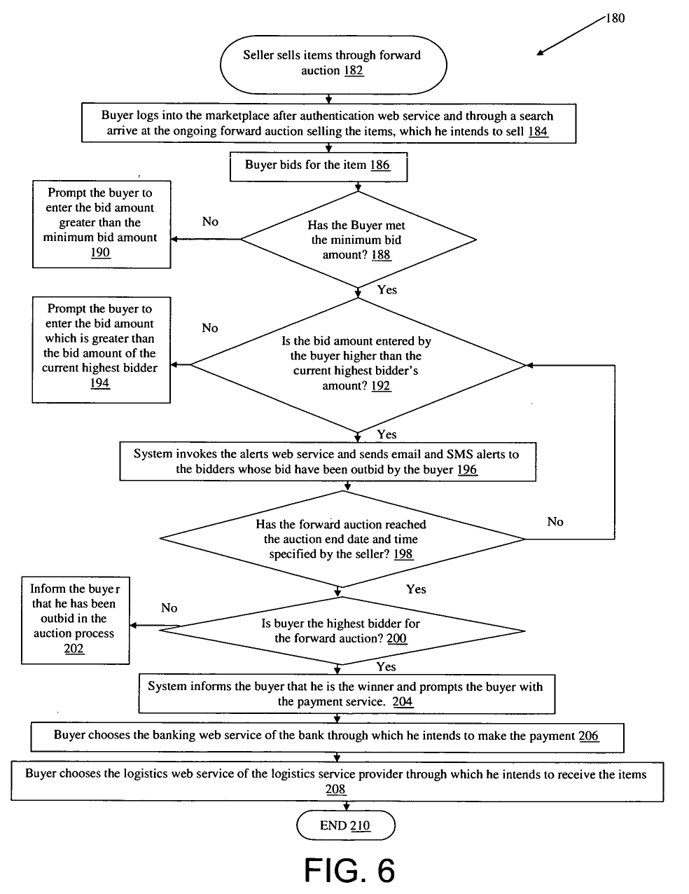

FIG. 6 is a flowchart illustrating a method 180 for selling items by the seller through forward auction, in accordance with an aspect of the present technique. The method 180 starts at step 182, wherein the seller sells items through forward auction. At step 184, the buyer logs into the marketplace after authentication by the authentication web service and through a search arrive at the ongoing forward auction selling the items, which he intends to buy. At step 186, the buyer bids for the item. At step 188, it is determined if the buyer has met the minimum bid amount. If he has met, then at step 192, it is determined if the bid amount entered by the buyer is higher than the current highest bidder's amount. If the answer is no, then at step 194, the system prompts the buyer to enter the bid amount, which is greater than the bid amount of the current highest bidder's amount. At step 196, the system invokes the alert web service and send email and short message service (SMS) alerts to the bidders whose bid have been outbid by the buyer. At step 198, it is determined if the forward auction reached the auction end date and time specified by the seller. If the answer is “no”, then the method goes back to step 192. If the answer is “yes”, then it is determined if the buyer is the highest bidder for the forward auction (block 200). If the answer is “yes”, then the system informs the buyer that he is the winner and prompts him with the payment service using the payment module (block 204). If the answer is “no”, then the system informs the buyer that he has been outbid in the auction process (block 202). The method 180 proceeds in step 206, wherein the buyer chooses the banking web service of the bank through which he intends to make the payment. In certain embodiment of the present technique, the seller may also be able to select at least one logistics service from where he would like to get the item delivered to the buyer. At step 208, the buyer chooses the logistics web service of the logistics service provider using the logistics module through which he intends to receive the item. In certain embodiment of the present technique, the seller may also be able to select at least one logistics service from where he would like to get the item delivered to the buyer. The method 180 concludes at step 210.

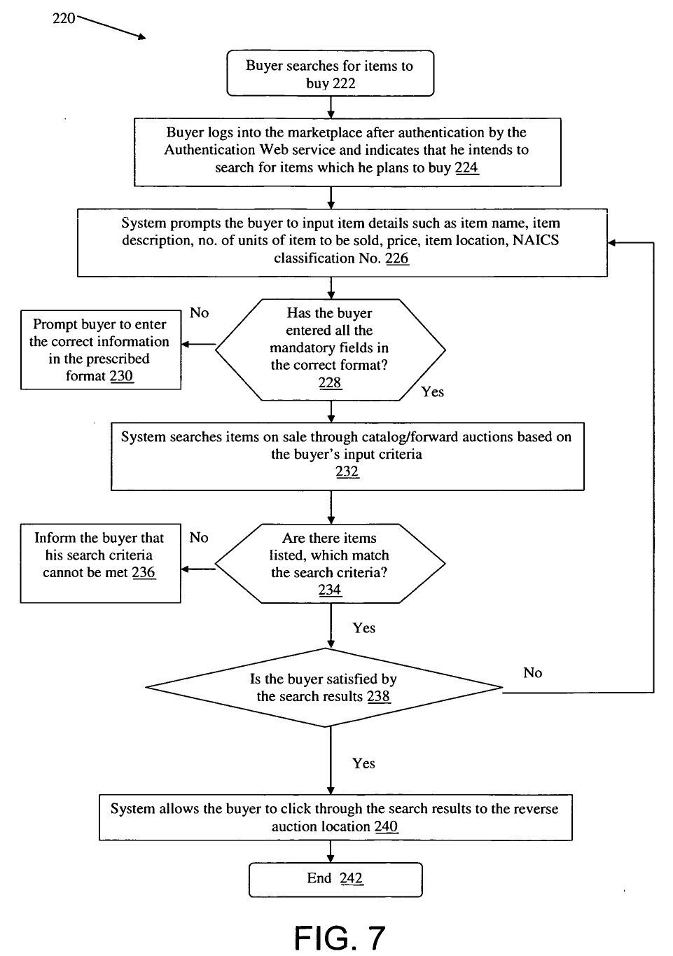

FIG. 7 is a flowchart illustrating a method 220 for searching items by the buyer, in accordance with an aspect of the present technique. The method 220 starts at step 222, wherein the buyer searches for items to buy. At step 224, the buyer logs into the marketplace after authentication by the authentication web service and indicate that he intends to search for items which he plans to buy. At step 226, the system prompts the buyer to input item details such as item name, item description, number of units of items to be sold, price, item location, NAICS classification number etc. At step 228, a decision is determined if the buyer entered all the mandatory fields in the correct format. If the answer is “no”, the system prompts the buyer to enter the correct information in the prescribed format (block 230). If the answer is “yes”, the system searches items on sale through catalog based procurement engine or forward auctions engine based on the buyer's inputted criteria. At step 234, it is determined if the items listed match the search criteria. If the answer is “no”, the system informs the buyer that his search criteria cannot be met (block 236). If the answer is “yes” then it is determined if the buyer is satisfied with the search results (block 238). If the buyer is not satisfied, then the method proceeds to step 226. If the buyer is satisfied, then the system allows the buyer to click through the search results to the forward auction or catalog based procurement location. The method concludes at step 242.

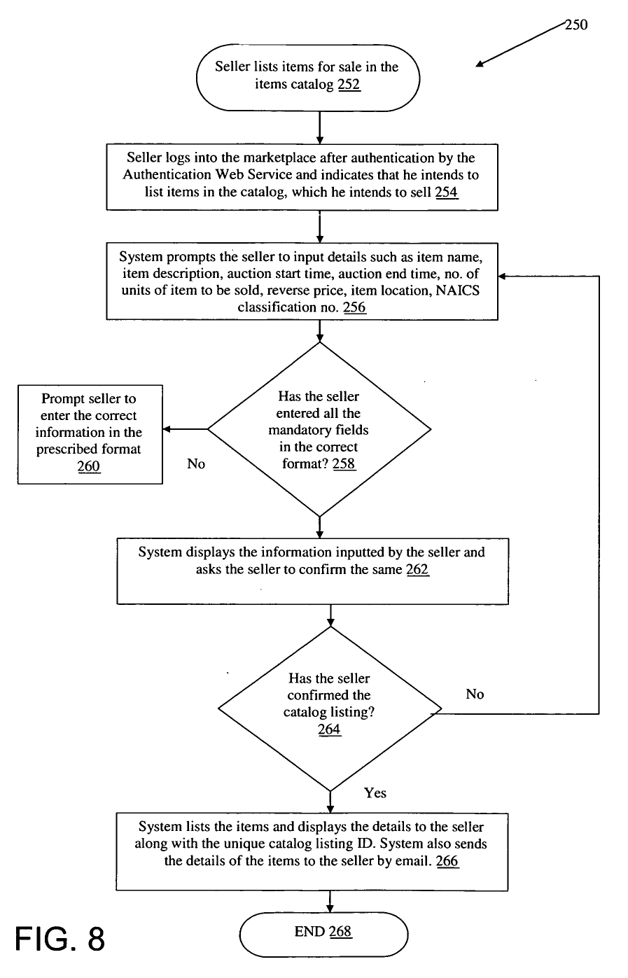

FIG. 8 is a flowchart illustrating a method 250 for listing items by the seller for sale in catalog based procurement service, in accordance with an aspect of the present technique. The method 250 starts at step 252, wherein the seller lists items for sale in the items listed in the catalog based procurement service engine. At step 254, the seller logs into the marketplace after authentication and indicates that he intends to list items in the catalog based procurement service, which he intends to sell. At step 256, the system prompts the buyer to input the reverse auction details such as item name, item description, auction start time, auction end time, number of units of item to be sold, reserve price, item location, NAICS classification number etc. At step 258, it is determined if the seller entered all the mandatory fields in the correct format. If the answer is “no”, then the system prompts the seller to enter the correct information in the prescribed format (block 260). If the answer is “yes”, the system displays the information inputted by the seller and asks the seller to confirm the same (block 262). At step 264, it is determined if the seller confirmed the catalog items. If the answer is “no”, then the method proceeds to step 256 or else the system lists the items and displays the details of the seller along with the unique catalog listing identification. In one embodiment of the present technique, the system also sends the details of the items to the seller by email (step 266). The method concludes at step 268.

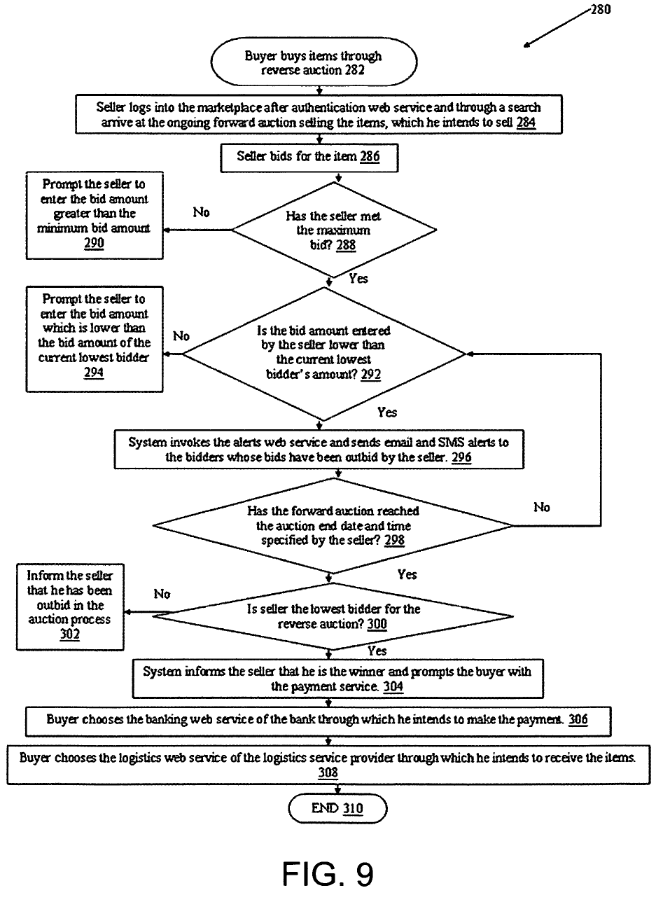

FIG. 9 is a flowchart illustrating a method 280 for buying items through reverse auction, in accordance with an aspect of the present technique. The method 280 starts at step 282 wherein the buyer buys items through reverse auction. At step 284, the seller logs into the marketplace after authentication by the authentication web service and through a search arrive at the ongoing forward auction selling the items, which he intends to sell. At step 286, the seller bids for the item. At step 288, it is determined if the seller has met the minimum bid amount. If he has met, then at step 292, it is determined if the bid amount entered by the seller is higher than the current lowest bidder's amount. If the answer is no, then at step 294, the system prompts the seller to enter the bid amount, which is lower than the bid amount of the current lowest bidder's amount. At step 296, the system invokes the alert web service and send email and short message service (SMS) alerts to the bidders whose bid have been outbid by the seller. At step 298, it is determined if the forward auction reached the auction end date and time specified by the seller. If the answer is “no”, then the method goes back to step 292. If the answer is “yes”, then it is determined if the seller is the lowest bidder for the reverse auction (block 300). If the answer is “yes” then the system informs the seller that he is the winner and prompts him with the payment service using the payment module (block 304). If the answer is “no”, then the system informs the buyer that he has been outbid in the auction process (block 302). The method 280 proceeds in step 306, wherein the buyer chooses the banking web service of the bank through which he intends to make the payment. In certain embodiment of the present technique, the seller may also be able to select at least one banking service from where he would like to get the payment from the buyer. At step 308, the buyer chooses the logistics web service of the logistics service provider using the logistics module through which he intends to receive the item. In certain embodiment of the present technique, the seller may also be able to select at least one logistics service from where he would like to get the item delivered to the buyer The method 280 concludes at step 310.

It should be noted that in addition to the above mentioned method steps as explained with reference to FIG. 2 to FIG. 9, in certain embodiment of the present technique, the method may also include conducting a procedure adapted for buyer payment history check and allocating a credit rating. The method may also include updating existing credit rating.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code. Note that the tangible media may comprise paper or another suitable medium upon which the instructions are printed. For instance, the instructions may be electronically captured via optical scanning of the paper or other medium, then compiled, interpreted or otherwise processed in a suitable manner if necessary, and then stored in a computer memory.

The sequence of instructions as explained in the method steps may include but not limited to, program code adapted for providing a reverse auction service to the at least one buyer for buying the item proposed by the at least one seller and a program code adapted for providing a catalog based procurement service to the at least one seller and the at least one buyer. The sequence of instructions may also include program code adapted for providing a payment service for providing credits and/or debits information to the at least one buyer and/or seller using a third party payment service. Furthermore, the sequence of instructions may include program code adapted for providing a logistics service to the at least one buyer for purchased items using a third party distribution service. It should be noted that the payment service and logistics service are provided using a web service interface.

In certain implementation of the present technique, the sequence of instruction may include program code adapted for providing a forward auction service to at least one seller for selling at least one item and a program code adapted for providing a reverse auction service to at least one buyer for buying the item proposed by the at least one seller. Furthermore, the sequence of instructions may also include program code adapted for providing a catalog based procurement service to the at least one seller and the at least one buyer.

As will be appreciated by a person skilled in the art, the various implementations of the present technique provide a variety of advantages. For example, supplier and buyer enablement is a key problem area in interorganisational commerce and the proposed method aims to address the same using Web services based open standard interfaces. The proposed new business method enables the participation of small/medium size suppliers into the enterprise value network. The purpose of the system and method is to provide ease of integration of supplier systems with the marketplaces of enterprises, thereby improving transaction efficiency and lead times for interorganisational commerce and collaboration. The method allows interoperability of enterprise systems with those of its suppliers thereby enhancing interorganisational collaboration and commerce. The method allows the inclusion of new suppliers into the enterprise network thereby enhancing interorganisational collaboration and commerce. The method allows interoperability of enterprise systems with those of its buyers thereby enhancing interorganisational collaboration and commerce. The method allows the inclusion of new buyers into the partner network thereby enhancing interorganisational collaboration and commerce. The supplier service network would provide the suppliers with a set of ready to consume services. The method offers seamless and non-obvious shift across enterprise systems, supplier systems, payment service providers and logistics service providers.

While, the following description id presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

What we claim is:

1. An automated method of enabling a real time transaction through a web service enabled supplier service network involving at least one supplier and at least one buyer, comprising:
providing a forward auction service to the at least one seller for selling at least one item;
providing a reverse auction service to the at least one buyer for buying the item proposed by the at least one seller;
providing a catalog based procurement service to the at least one seller and the at least one buyer;
providing a payment service for providing credits and/or debits information to the at least one buyer and/or seller using a third party payment service; and
providing a logistics service to the at least one buyer for purchased items using a third party distribution service;
wherein, the payment service and logistics service are provided using a web service interface.

2. The method of claim 1, wherein the forward auction option further includes option of entering a plurality of information to be entered by the at least one seller or buyer or both.

3. The method of claim 2, wherein the reverse auction option further includes option of entering the plurality of information to be entered by the at least one buyer or seller or both.

4. The method of claim 3, wherein the plurality of information includes at least one of time out, reserve price, or combinations thereof.

5. The method of claim 1, further comprising option of including at least one of new suppliers or new buyers or combinations thereof to the web services enabled supplier service network.

6. The method of claim 1, wherein the catalog based procurement service further provides option of at least one of selecting the at least one item, or identifying suppliers based on the expectations of the at least one buyer, or combinations thereof.

7. The method of claim 1, wherein the real time transaction includes at least one of selling or buying or making payments or receiving payments or distribution or delivery deadlines or combinations thereof.

8. The method of claim 1, wherein the forward auction service removes the at least one item from the catalog based procurement service once the real time transaction is completed.

9. The method of claim 1, further comprising a display module adapted for displaying buyer specific catalog based on pre-set preferences.

10. The method of claim 9, wherein the display module further displays seller specific catalog based on items for sale.

11. The method of claim 9, further comprising displaying transportation options using the display module.

12. The method of claim 11, wherein the transportation options include at least one of mode of delivery, or time of delivery or combinations thereof.

13. A system of enabling a real time transaction through a web service enabled supplier service network involving at least one supplier and at least one buyer, comprising:
a process engine operable to execute a plurality of services to perform the real time transaction based on a workflow;
a database operable to store a plurality of data relating to the real time transaction;
a display module configured to display information on the real time transaction;
a payment module adapted for providing a third party payment service for determining and processing payment terms of the at least one buyer or the at least one seller; and
a logistics module adapted for providing a third party logistics service to the at least one buyer or the at least one seller for purchased items using a third party distribution service;
wherein, the payment service and logistics service are provided using a web service interface.

14. The system of claim 13, wherein the real time transaction includes at least one of selling or buying or paying or receiving payments or distribution or delivery deadlines or combinations thereof.

15. The system of claim 13, wherein the information displayed on the display module includes at least one of buyer specific catalog based on pre-set preferences or seller specific catalog based on items for sale or transportation options or combinations thereof.

16. The system of claim 13, wherein the plurality of services includes at least one of providing a forward auction service to the at least one seller for selling at least one item or providing a reverse auction service to the at least one buyer for buying the item proposed by the at least one seller or providing a catalog-based procurement service to the at least one seller and the at least one buyer or combinations thereof.

17. A computer program product tangibly embodying a plurality of instructions for enabling a real time transaction through a web service enabled supplier service network involving at least one supplier and at least one buyer, comprising:
a computer readable medium configured to store:
program code adapted for providing a reverse auction service to the at least one buyer for buying the item proposed by the at least one seller;
program code adapted for providing a catalog based procurement service to the at least one seller and the at least one buyer;
program code adapted for providing a payment service for providing credits and/or debits information to the at least one buyer and/or seller using a third party payment service; and
program code adapted for providing a logistics service to the at least one buyer for purchased items using a third party distribution service;
wherein, the payment service and logistics service are provided using a web service interface.

18. The computer program product of claim 17, further comprising option of including new suppliers to the web services enabled supplier service network.

19. The computer program product of claim 17, wherein the catalog based procurement service further provides option of at least one of selecting the at least one item, or identifying suppliers based on the expectations of the at least one buyer, or combinations thereof.

20. The computer program product of claim 17, further comprising a program code adapted for displaying information on the real time transaction using a display module.

21. An automated method of enabling a real time transaction through a web service enabled supplier service network, comprising:
providing a forward auction service to at least one seller for selling at least one item;
providing a reverse auction service to at least one buyer for buying the item proposed by the at least one seller; and
providing a catalog based procurement service to the at least one seller and/or the at least one buyer;
wherein, the payment service and logistics service are provided using a web service interface.

22. The method of claim 21, further comprising providing a payment service for providing credits and/or debits information to the at least one buyer and/or seller using a third party payment service.

23. The method of claim 21, further comprising providing a logistics service to the at least one buyer for purchased items using a third party distribution service.

24. The method of claim 21, wherein the catalog based procurement service further provides option of at least one of selecting the at least one item, or identifying suppliers based on the expectations of the at least one buyer, or combinations thereof.

25. The method of claim 21, wherein the real time transaction includes at least one of selling or buying or paying or receiving payments or distribution or delivery deadlines or combinations thereof.

26. The method of claim 21, further comprising displaying information on the real time transaction using a display module.

27. The method of claim 21, wherein the forward auction service removes the at least one item from the catalog once the real time transaction is completed.

28. The method of claim 21, further comprising storing a plurality of data relating to the real time transaction using a database.
